(19) United States
(12) Patent Application Publication
(10) Pub. No.: US 2016/0169789 A1
(43) Pub. Date: Jun. 16, 2016

(54) TEST CHAMBER

(71) Applicants: Fu Tai Hua Industry (Shenzhen) Co., Ltd., Shenzhen (CN); HON HAI PRECISION INDUSTRY CO., LTD., New Taipei (TW)

(72) Inventors: CHAO CHEN, Shenzhen (CN); MING WANG, Shenzhen (CN); ZHAO MA, Shenzhen (CN)

(21) Appl. No.: 14/597,462

(22) Filed: Jan. 15, 2015

(30) Foreign Application Priority Data
Dec. 12, 2014 (CN) 201410771849.9

(51) Int. Cl. G01N 17/00

(52) U.S. Cl. CPC G01N 17/002

(57) ABSTRACT

A test chamber for testing electronic devices within includes a cabinet, a charging station attached to the cabinet, and a control station capable of running test programs to test performances of routine functions and charging performance of the electronic devices. The charging station includes a DC power supply, and a plurality of power output ports connected in parallel and connected with the DC power supply. When testing performances of routine functions of the electronic devices, the DC power supply is capable of powering each electronic device; and when testing respective charging performances of the electronic devices, a plurality of cables are connected between the power output ports and the electronic devices.

### FIELD

The subject matter herein generally relates to a test chamber.

### BACKGROUND

Traditional test chambers are seldom configured with direct current (DC) power output ports for providing DC power.

### BRIEF DESCRIPTION OF THE DRAWINGS

Implementations of the present technology will now be described, by way of example only, with reference to the attached figures.

FIG. 1 is an isometric view of an embodiment of a test chamber.

FIG. 2 is an isometric view of the test chamber, wherein a cover of the test chamber is open.

FIG. 3 is an enlarged view of portion III of FIG. 2.

FIG. 4 is an isometric view of the test chamber when the test chamber is in a state of use.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” when utilized, means “including, but not necessarily limited to”; it specifically indicates open-ended inclusion or membership in the so-described combination, group, series and the like.

The present disclosure is described in relation to a test chamber.

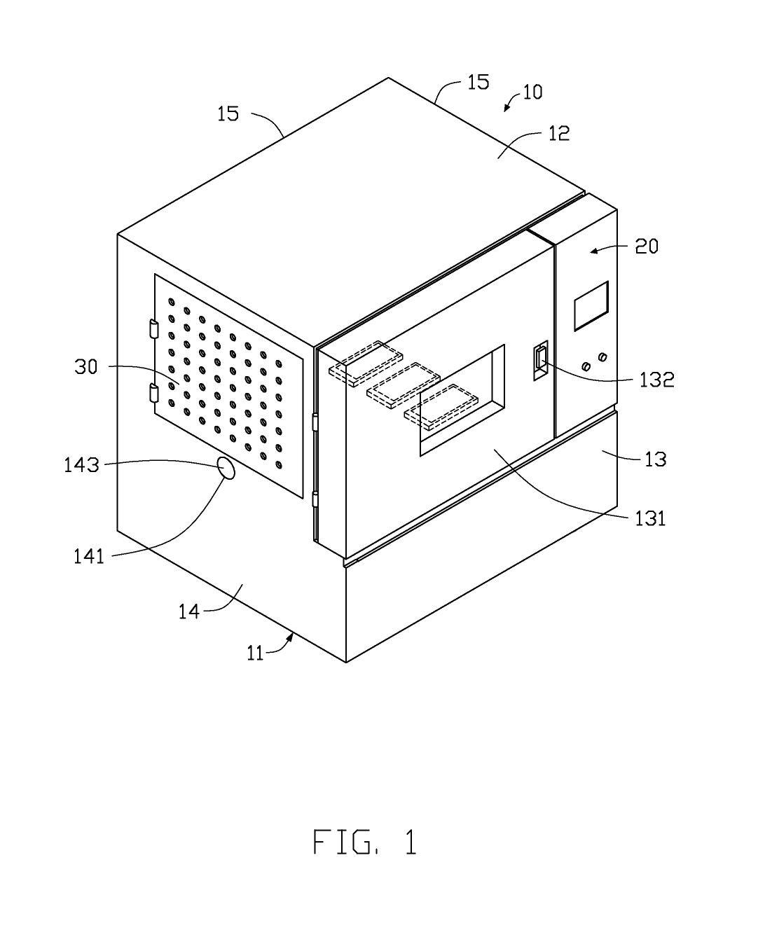

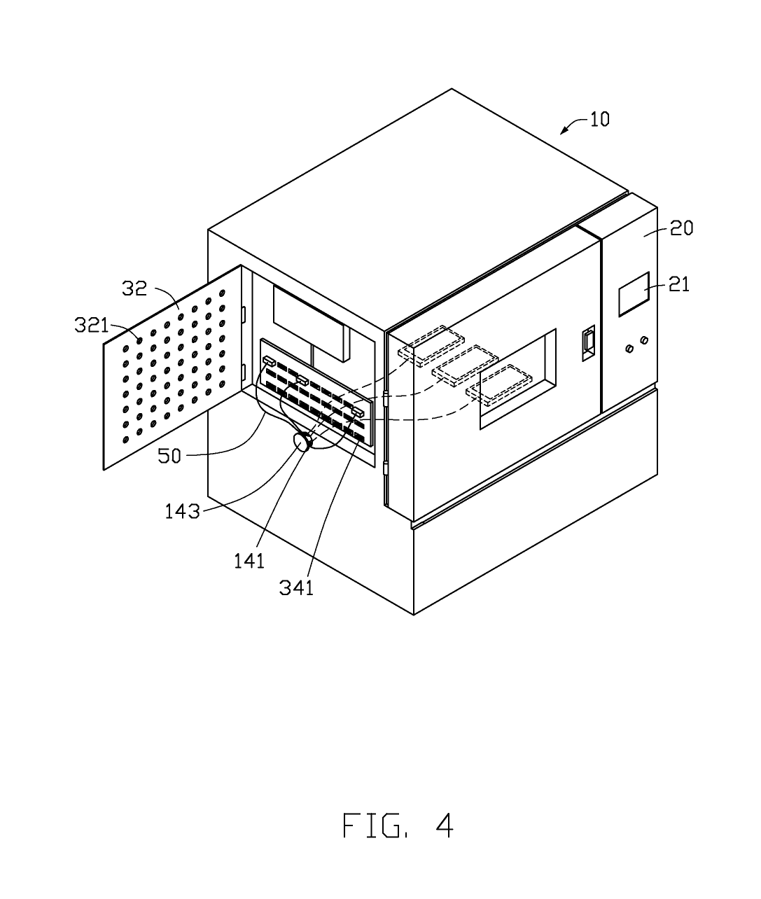

FIG. 1 illustrates an embodiment of a test chamber for selectively testing performances of routine functions and charging performances of a plurality of electronic devices located therein. The chamber comprises a cabinet 10, a control station 20, a charging station 30, and a plurality of cables 50 (shown in FIG. 4).

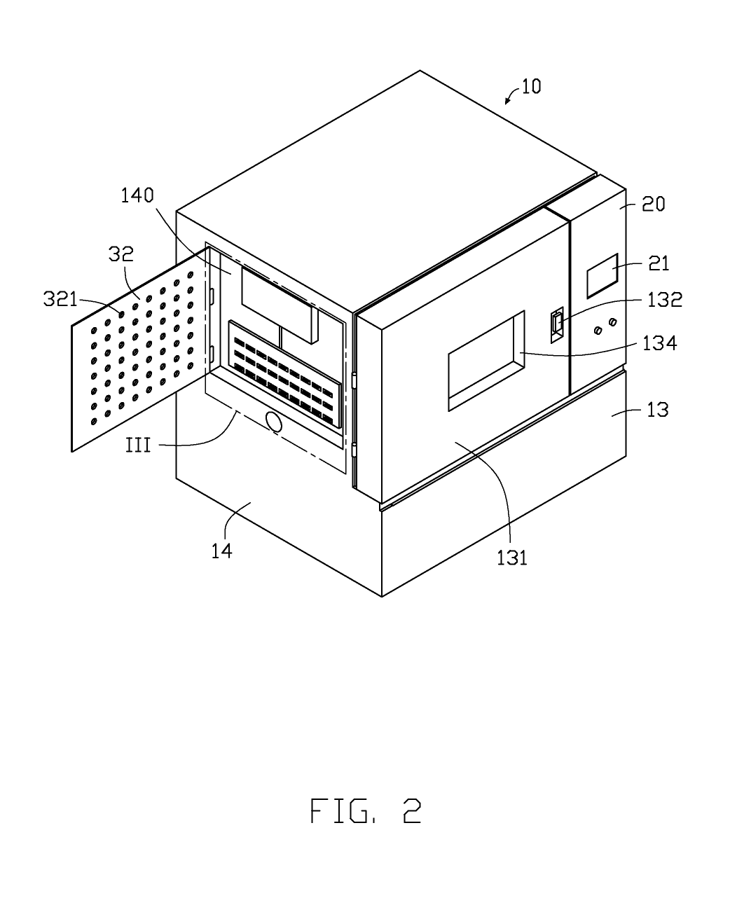

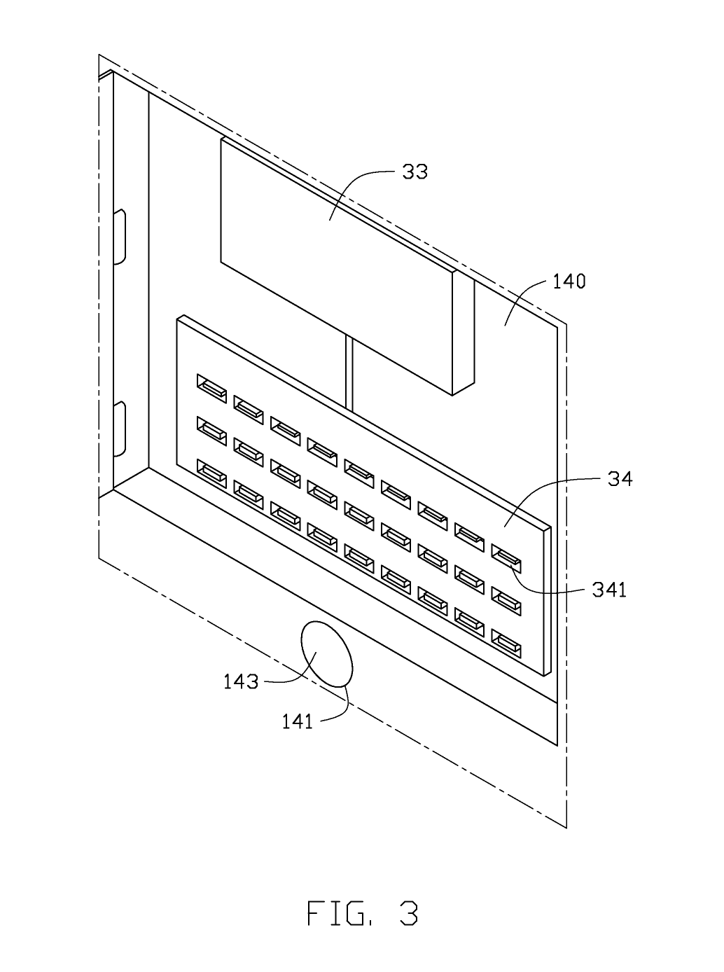

The cabinet 10 comprises a generally rectangular bottom plate 11, a top plate 12 parallel to the bottom plate 11, a first side plate 13, a second side plate 14, and two third side plates 15. The first side plate 13, the second side plate 14, and the third side plates 15 are perpendicular to the bottom plate 11. A door 131 is pivotably attached to an upper portion of the first side plate 13 by a plurality of hinges 130 (shown in FIG. 2) and latched to the first side plate 13 by a latch 132 (shown in FIG. 2). A transparent window 134 is disposed in a middle portion of the door 131, for observation. A rectangular recessed portion 140 (shown in FIG. 2) is defined in the second side plate 14 for receiving the charging station 30 therein. A cover 32 is pivotably attached to the second side plate 14 to cover the recessed portion 140 and comprises a plurality of vents 321 defined therein. An opening 141 is defined in the second side plate 14, below the recessed portion 140. A plug 143 is removably plugged into the opening 141 and made of flexible materials, such as rubber. The plug 143 is shown in FIG. 3 in the closed position, and in FIG. 4 in the open position.

The control station 20 is attached to the first side plate 13 beside the door 131 and near one of the third side plates 15. The control station 20 comprises an operating portion 21. Operating the operating portion 21 can set parameters inside of the cabinet 10, such as temperature and humidity.

FIG. 2 and FIG. 3 illustrate that the charging station 30 comprises a DC power supply 33 and a DC power output portion 34. The DC power output portion 34 comprises a plurality of power output ports 341. The DC power supply 33 is coupled to an alternating current (AC) power supply. The DC power supply 33 can convert an AC voltage of the AC power supply to a steady DC voltage. The power output ports 341 are connected in parallel and, electrically connected to the DC power supply 33. In this embodiment, the power output ports 341 are USB sockets.

The cables 50 are capable of extending through the opening 141 to couple the power output ports 341 to the electronic devices.

Referring to FIG. 1, to test performances of routine functions of the electronic devices, the electronic devices are placed into the cabinet 10 when the door 131 is opened. Then the door 131 is closed and latched to the first side plate 13 by the latch 132. The cover 32 is closed and the plug 143 is plugged into the opening 141. The operating portion 21 of the control station 20 is operated to set environmental parameters inside of the cabinet 10.

Referring to FIG. 4, to test routine performances of the electronic devices requiring DC power, or to test charging performances of the electronic devices, the door 131 and the cover 32 are opened and the plug 143 is unplugged. The cables 50 extend through the opening 141 of the second side plate 14 and are connected between the electronic devices and the power output ports 341. Then, the door 131 is closed and latched to the first side plate 13 by the latch 132. The plug 143 is plugged into the opening 141. The operating portion 21 of the control station 20 is operated to set environmental parameters inside of the cabinet 10.

In another embodiment, the plug 143 can be made of rigid materials. The plug 143 comprises a cutout for the cables 50 extending therethrough and a block slidably attached to the plug 143. The block can be slid to extend into the cutout and be withdrawn into the plug 143.

In a further embodiment, the charging station 30 can be installed in the cabinet 10 and the opening 141 and the plug 143 can be omitted.

The test chamber can be a constant temperature test chamber, a constant humidity test chamber, or a variable temperature test chamber.

The embodiments shown and described above are only examples. Many details are well known by those in the art therefore many such details are neither shown nor described. Even though numerous characteristics and advantages of the present technology have been set forth in the foregoing description, together with details of the structure and function of the present disclosure, the disclosure is illustrative only, and changes may be made in the details, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A test chamber for testing electronic devices located therein, the chamber comprising:
a cabinet;
a charging station attached to the cabinet and comprising a DC power supply, and a plurality of power output ports connected in parallel and connected with the DC power supply; and
a control station capable of setting environmental parameters inside of the cabinet to test performances of the electronic devices;
wherein to test routine performances of the electronic devices requiring DC power, or to test charging performances of the electronic devices, a plurality of cables are connected between the power output ports and the electronic devices.

2. The test chamber of claim 1, wherein the control station comprises an operating portion to set environmental parameters inside of the cabinet.

3. The test chamber of claim 2, wherein the cabinet comprises a first side plate, the control station is attached to the first side plate.

4. The test chamber of claim 3, wherein a door is pivotably attached to the first side plate beside the control station, the door is opened to allow the electronic devices to enter into the cabinet.

5. The test chamber of claim 3, wherein the cabinet further comprising a second side plate perpendicular to the first side plate, a recessed portion is defined in the second side plate to receive the charging station therein, a cover is pivotably attached to the second plate to cover the recessed portion.

6. The test chamber of claim 5, wherein an opening is defined in the second side plate below the recessed portion for the cables extending therethrough.

7. The test chamber of claim 6, wherein a plug is removable plugged in the opening.

8. The test chamber of claim 5, wherein a plurality of vents is defined in the cover.

9. The test chamber of claim 1, wherein the DC power supply is configured to be coupled to an AC power supply and convert an AC voltage of the AC power supply to a DC voltage.

10. A test chamber configured to test electronic devices located therein, the chamber comprising:
a cabinet having an interior;
an environmental control station configured to control the environment in the interior of the cabinet;
a charging station integrated into to the exterior of the cabinet, the charging station including a DC power supply and a plurality of power output ports connected to the DC power supply; and
an opening in the cabinet configured to allow at least one cable to pass there through to connect an electronic device within the chamber to the charging station outside the chamber.

11. The test chamber of claim 10, wherein the control station comprises an operating portion to set environmental parameters inside of the cabinet.

12. The test chamber of claim 11, wherein the cabinet comprises a first side plate, the control station is attached to the first side plate.

13. The test chamber of claim 12, wherein a door is pivotably attached to the first side plate beside the control station, the door is opened to allow the electronic devices to enter into the cabinet.

14. The test chamber of claim 12, wherein the cabinet further comprising a second side plate perpendicular to the first side plate, the charging station is integrated into the second side plate.

15. The test chamber of claim 14, wherein the opening is configured in the second side plate below the charging station.

16. The test chamber of claim 15, wherein a plug is removable plugged in the opening.
